(19) United States
(12) Patent Application Publication
(10) Pub. No.: US 2026/0094922 A1
(43) Pub. Date: Apr. 2, 2026

(54) MOUNTING RACK FOR ENERGY STORAGE BATTERY

(71) Applicant: AVERTRONICS INC., Taichung City (TW)

(72) Inventors: Austin Lai, Taichung City (TW); Kuan Ching Lee, Taichung City (TW); Kai Yang Cheng, Taichung City (TW)

(21) Appl. No.: 18/900,431

(22) Filed: Sep. 27, 2024

(51) Int. Cl. H01M 50/267; H01M 50/242; H01M 50/244; H01M 50/264

(52) U.S. Cl. CPC H01M 50/267; H01M 50/242; H01M 50/244; H01M 50/264

(57) ABSTRACT

A mounting rack for energy storage battery may include fixed platform, at least an adjusting frame, and two abutting frames. Each of two lateral sides of the fixed platform has a guide rail, and the adjusting frame and the abutting frames are adapted to slide along the guide rail. The adjusting frame comprises a top adjustment member, and an adjustment protrude protrudes from the center of the top adjustment member, and each of two lateral sides of the adjustment protrude has a top wing plate. Each of the front and rear sides of the top wing plate comprises an elongated hole and a side adjustment member, and a clamping portion protrudes from the center of the side adjustment member.

### FIELD OF THE INVENTION

The present invention relates to a mounting rack and more particularly to a mounting rack that can be flexibly adjusted to secure different sizes of energy storage batteries.

### BACKGROUND OF THE INVENTION

Depending on the type, some energy storage batteries may contain electrolytes, so that it is important to ensure that the batteries and associated devices are not subjected to excessive shaking, collisions, or movement during use. Thus, the fixation of energy storage batteries should be given significant attention. Since the number, size, and dimensions of the batteries can vary, and it is inconvenient and cost-increasing that the user needs to customize the racks to fit different sizes of batteries. Therefore, there remains a need for a new and improved design for a mounting rack for energy storage battery to overcome the problems presented above.

### SUMMARY OF THE INVENTION

The present invention provides a fixed platform, at least an adjusting frame, and two abutting frames. Each of two lateral sides of the fixed platform has a guide rail, and a plurality of sliding plates are abutted against the inner top surface of the guide rail, and each of the guide rails has a guide groove formed at the top thereof. The adjusting frame comprises a top adjustment member, and an adjustment protrude protrudes from the center of the top adjustment member, and each of two lateral sides of the adjustment protrude has a top wing plate. A height difference is formed between the adjustment protrude and the top wing plates, and the adjustment protrude is secured at the front and rear by a nut paired with a screw rod which passes through the guide groove and locks with a sliding plate, so that the adjusting frame is adapted to slide along the guide rail. Each of the front and rear sides of the top wing plate comprises an elongated hole and a side adjustment member, and a clamping portion protrudes from the center of the side adjustment member. Each of two sides of the clamping portion has a bottom wing plate, and a stop plate is formed at the rear end of the bottom wing plate. The adjustment protrude is configured to snap and engage into the clamping portion, and each of two adjacent elongated holes has a screw passing therethrough to pair with a nut, so as to assemble the top wing plate with the side adjustment member, and the side adjustment member is adapted to slide back and forth relative to the top adjustment member. The abutting frame has an abutting plate at one lateral side thereof, and the front and rear of the abutting frame are secured with a nut paired with a screw which passes through the guide groove and locks with a sliding plate, so that the abutting frame is configured to slide along the guide rail. At least a battery is positioned on the fixed platform, and the two abutting frames are configured to slide and approach to the two lateral sides of the battery, and the abutting plates are abutted against the two lateral sides of the battery, thereby securing the battery from the two lateral sides thereof. The top wing plate is abutted against the top surface of the battery, and the movable stop plates are adapted to move to abut against the front side and rear side of the battery, so as to secure the position of the battery by pressing from six directions thereof. The adjustment protrude is faced up to only abut the top wing plate against the battery. The adjustment protrude is faced down to insert and engage into the clamping portion so that the adjustment protrude is positioned between the two batteries so as to achieve the separating effect. by tightening the sliding plates, the nuts, the screw rods, and the screws, the guide rails, the adjusting frame, and the abutting frames are securely positioned so as to ensure that the battery is tightly fixed in position.

Comparing with conventional mounting rack for battery, the present invention is advantageous because: The adjusting frame and the abutting frames are configured to slide along the guide rails, so as to adjust the positions of the top wing plates, the stop plates, the abutting frames, cooperating the fixed platform to abut against the surface of the battery, so that the battery is secured from six directions to ensure the stability and fixation of the battery and increase the practicability in use. Thus, the mounting rack of the present invention is adapted to be adjusted based on the size of the battery by sliding the components accordingly. In addition, the adjustment protrude is configured to be faced up or down to achieve the pressing against the battery or sperate the two adjacent batteries, so that the present invention of the mounting rack is used in the case where multiple batteries need to be separated, further enhancing it flexibility in application.

### BRIEF DESCRIPTION OF THE DRAWINGS

FIG. 1 is a three-dimensional assembly view of a mounting rack for energy storage battery of the present invention.

FIG. 2 is an exploded view of the mounting rack for energy storage battery of the present invention.

FIG. 3 is an exploded view of an adjusting frame and an abutting frame of the mounting rack of the present invention.

FIG. 4 is a lateral view and its partial enlarged view of the mounting rack for energy storage battery of the present invention.

FIG. 5 is a front sectional view and its partial enlarged view of the mounting rack for energy storage battery of the present invention.

FIG. 6 is a front sectional view of a first embodiment of the mounting rack for energy storage battery of the present invention.

FIG. 7 is a front sectional view of a second embodiment of the mounting rack for energy storage battery of the present invention.

FIG. 8 is a front sectional view of a third embodiment and its partial enlarged view of the adjusting frame of the mounting rack for energy storage battery in the present invention.

FIG. 9 is a front sectional view of the third embodiment of the mounting rack for energy storage battery of the present invention.

FIG. 10 is a front sectional view of a fourth embodiment of the mounting rack for energy storage battery of the present invention.

FIG. 11 is a schematic view of the mounting rack for energy storage battery of the present invention when in use.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

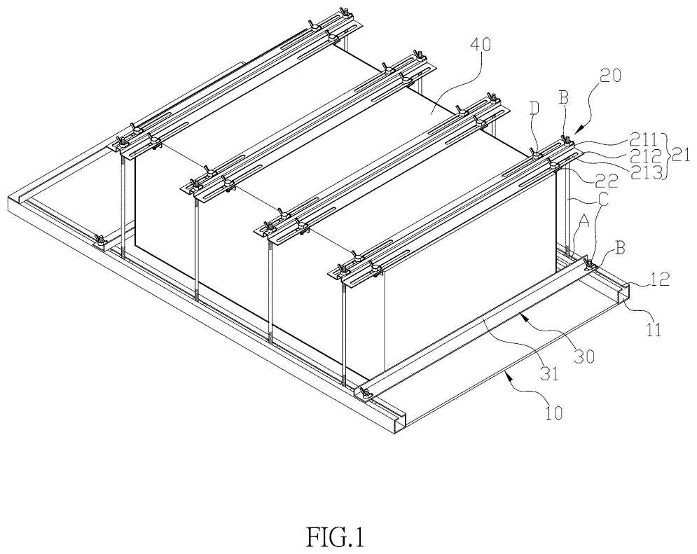

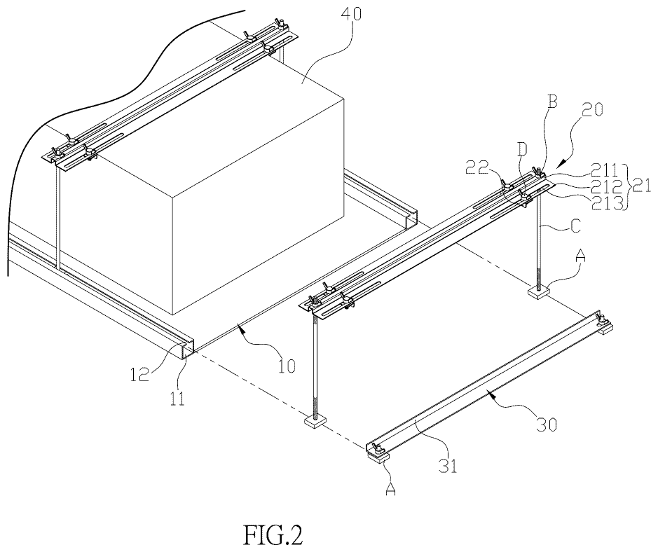

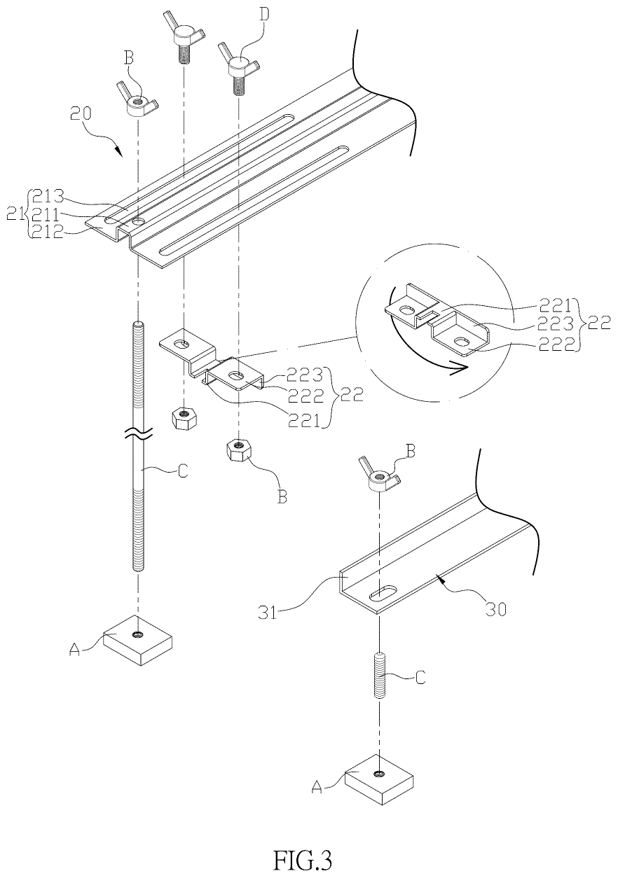

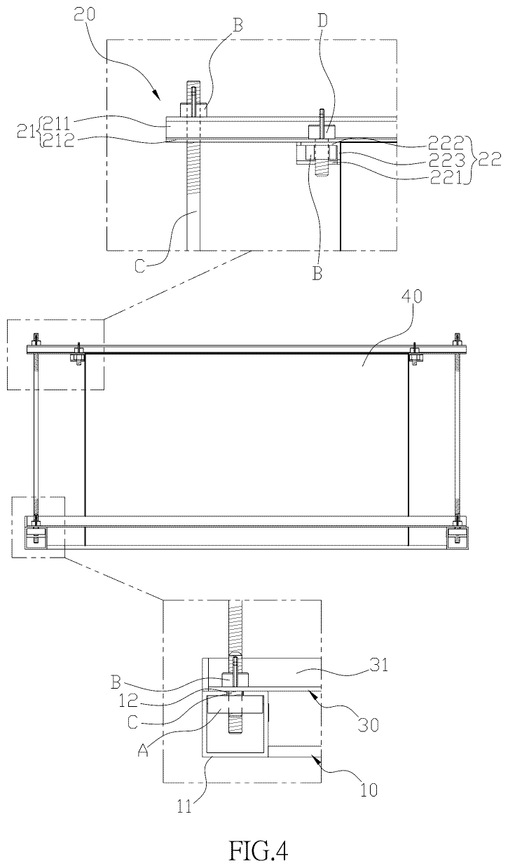

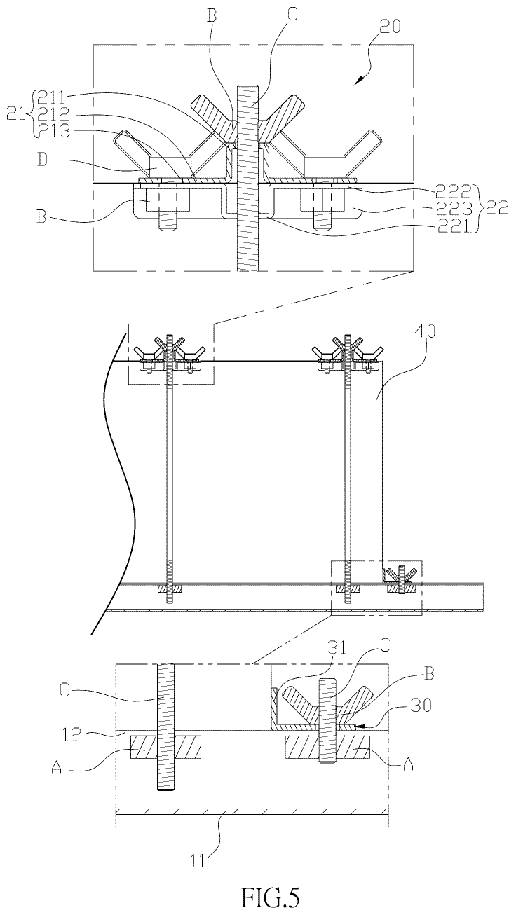

Referring to FIGS. 1 to 5, the present invention provides a mounting rack for energy storage battery comprising a fixed platform (10), at least an adjusting frame (20), and two abutting frames (30). Each of two lateral sides of the fixed platform (10) has a guide rail (11), and a plurality of sliding plates (A) are abutted against the inner top surface of the guide rail (11), and each of the guide rails (11) has a guide groove (12) formed at the top thereof.

The adjusting frame (20) comprises a top adjustment member (21), and an adjustment protrude (211) protrudes from the center of the top adjustment member (21), and each of two lateral sides of the adjustment protrude (211) has a top wing plate (212). A height difference is formed between the adjustment protrude (211) and the top wing plates (212), and the adjustment protrude (211) is secured at the front and rear by a nut (B) paired with a screw rod (C) which passes through the guide groove (12) and locks with a sliding plate (A), so that the adjusting frame (20) is adapted to slide along the guide rail (11). Each of the front and rear sides of the top wing plate (212) comprises an elongated hole (213) and a side adjustment member (22), and a clamping portion (221) protrudes from the center of the side adjustment member (22). Moreover, each of two sides of the clamping portion (221) has a bottom wing plate (222), and a stop plate (223) is formed at the rear end of the bottom wing plate (222). The adjustment protrude (211) is configured to snap and engage into the clamping portion (221), and each of two adjacent elongated holes (213) has a screw (D) passing therethrough to pair with a nut (B), so as to assemble the top wing plate (212) with the side adjustment member (22), and the side adjustment member (22) is adapted to slide back and forth relative to the top adjustment member (21).

The abutting frame (30) has an abutting plate (31) at one lateral side thereof, and the front and rear of the abutting frame (30) are secured with a nut (B) paired with a screw (C) which passes through the guide groove (12) and locks with a sliding plate (A), so that the abutting frame (30) is configured to slide along the guide rail (11).

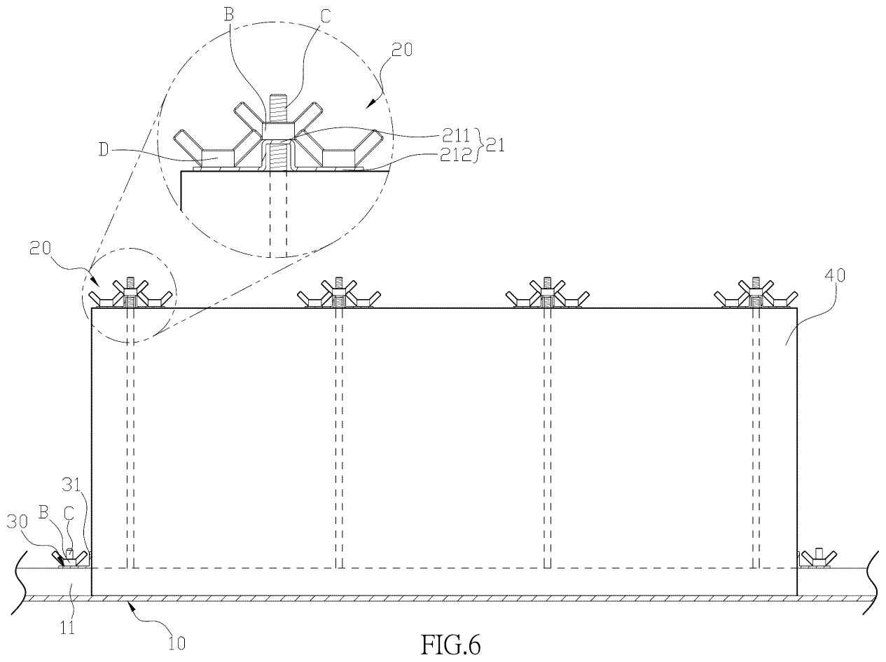

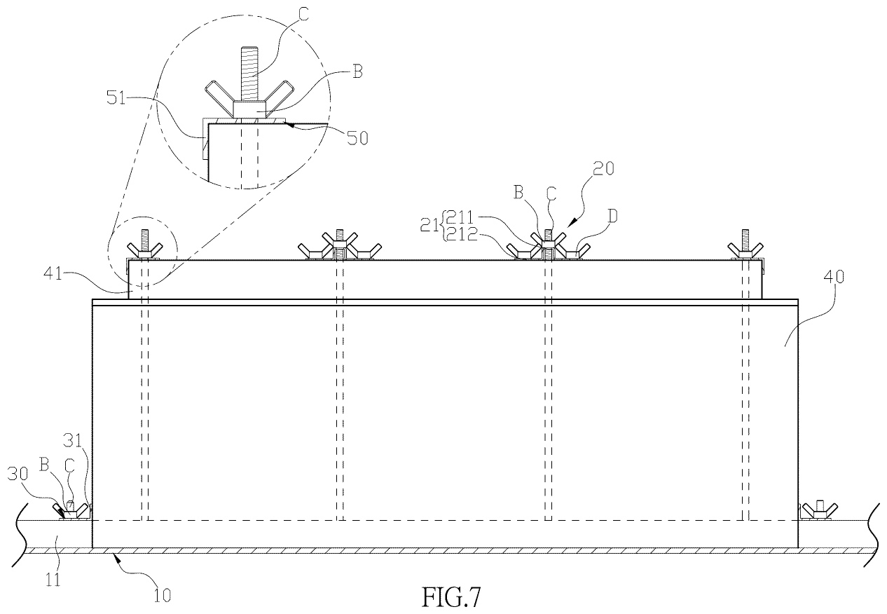

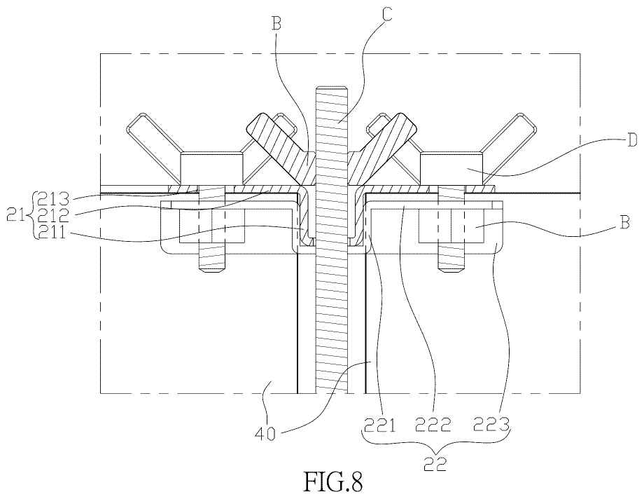

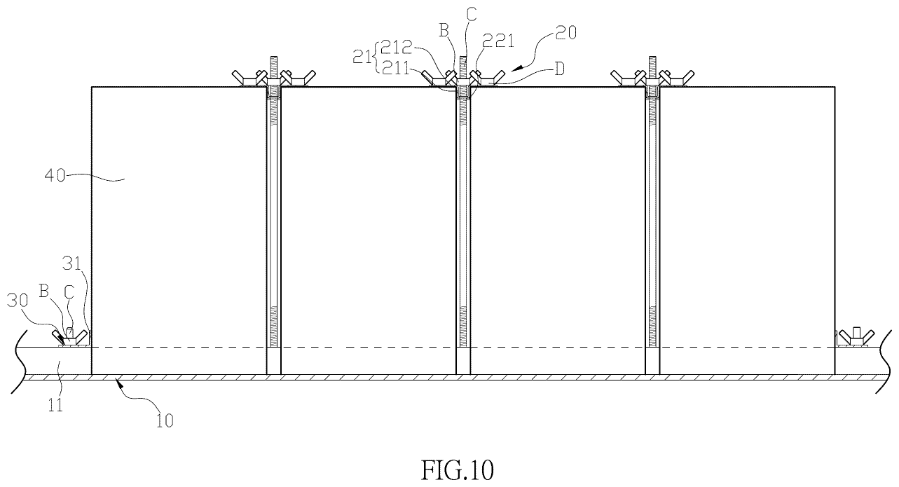

At least a battery (40) is positioned on the fixed platform (10), and the two abutting frames (30) are configured to slide and approach to the two lateral sides of the battery (40), and the abutting plates (31) are abutted against the two lateral sides of the battery (40), thereby securing the battery (40) from the two lateral sides thereof. Also, the top wing plate (212) is abutted against the top surface of the battery (40), and the movable stop plates (223) are adapted to move to abut against the front side and rear side of the battery, so as to secure the position of the battery (40) by pressing from six directions thereof. Referring to FIGS. 6 and 7, the adjustment protrude (211) is faced up to abut the top wing plate (212) against the battery (40) only. Referring to FIGS. 8 to 10, the adjustment protrude (211) is faced down to insert and engage into the clamping portion (221) so that the adjustment protrude (211) is positioned between the two batteries (40) so as to achieve the separating effect. Moreover, by tightening the sliding plates (A), the nuts (B), the screw rods (C), and the screws (D), the guide rails (11), the adjusting frame (20), and the abutting frames (30) are securely positioned so as to ensure that the battery (40) is tightly fixed in position.

The adjusting frame (20) and the abutting frames (30) are configured to slide along the guide rails (11), so as to adjust the positions of the top wing plates (212), the stop plates (223), the abutting frames (31), cooperating the fixed platform (10) to abut against the surface of the battery (40), so that the battery (40) is secured from six directions to ensure the stability and fixation of the battery (40) and increase the practicability in use. Thus, the mounting rack of the present invention is adapted to be adjusted based on the size of the battery (40) by sliding the components accordingly. In addition, the adjustment protrude (211) is configured to be faced up or down to achieve the pressing against the battery (40) or sperate the two adjacent batteries (40), so that the present invention of the mounting rack is used in the case where multiple batteries need to be separated, further enhancing it flexibility in application.

Referring to FIGS. 6 and 7, in the first and second embodiments of the present invention, the number of battery (40) is one which is a complete battery type such as a lithium battery. The adjustment protrudes (211) are faced up to enable only the top wing plates (212) to abut against the battery (40), and the top wing plates (212) and the fixed platform (10) are configured to respectively abut against the top and bottom of the battery (40). Also, the stop plates (223) of the side adjustment members (22) are adapted to abut against the front and rear side of the battery (40), while the abutting plates (31) of the abutting frames (30) are configured to abut against two lateral sides of the battery (40), so as to secure the battery (40) from six directions.

Referring to FIGS. 8 to 10, in the third and fourth embodiments of the present invention, the number of the batteries (40) is multiple, and the batteries (40) are in a multiple configuration, such as lead-acid batteries that need to be connected in parallel or series. The adjustment protrudes (211) are faced down to insert and engage into the clamping portions (221), and the top wing plates (212) are abutted against the batteries (40), and the adjacent batteries (40) are separated and kept at a distance by the adjustment protrudes (211). The top wing plates (212) and the fixed platform (10) are respectively abutted against the top and bottom of the batteries (40), and the stop plates (223) of the side adjustment members (22) are configured to abut against the front and rear sides of the batteries (40), and the abutting plates (31) are adapted to abut against the two lateral sides of the batteries (40), so as to secure the batteries (40) from six directions.

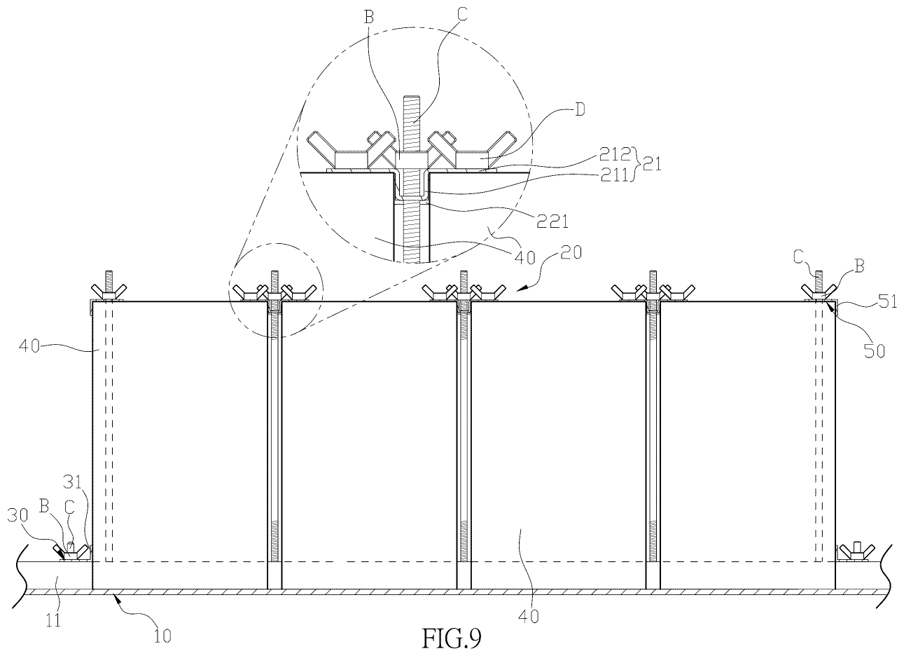

Referring to FIGS. 7 and 9, in one embodiment, the present invention has two auxiliary limiting frames (50), and each of the auxiliary limiting frames (50) has a limiting plate (51) at one lateral side thereof. The auxiliary limiting frames (50) are adapted to abut against the two top lateral sides of the battery (40), and the auxiliary limiting frame (50) is secured at the front and rear by using a nut (B) and a screw (C), which passes through the guide groove (12) and is locked onto a sliding plate (A), so as to enable the auxiliary limiting frame (50) to slide along the guide rail (11). Also, the limiting plates (51) are abutted against the two lateral sides of the battery (40), thereby securing the position of the battery (40) firmly.

Referring to FIG. 7, a cover (41) is formed on the top of the battery (40), and the cover (41) is configured to make contact with the adjusting frame (20) or the auxiliary limiting frame (50) to prevent the adjusting frame (20) or the auxiliary limiting frame (50) from directly pressing against the battery (40).

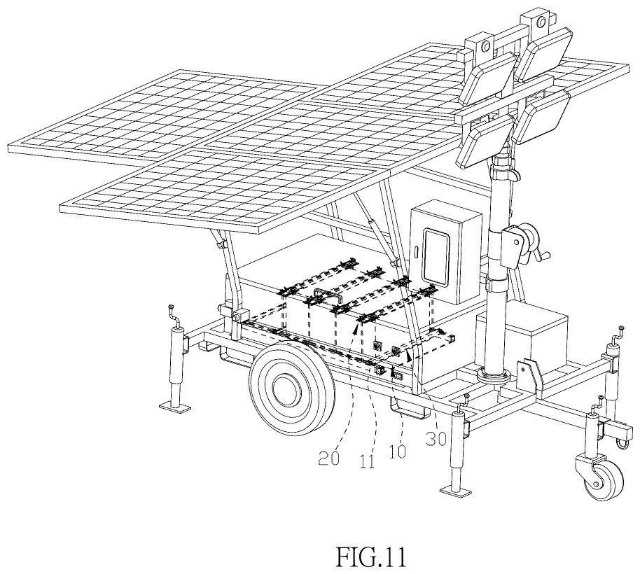

In actual application, the adjusting frames (20), and the abutting frames (30) are adapted to restrict and secure the position of the battery (40) in six directions. The optimal shape of the battery (40) is a cubic or rectangular hexahedron. As shown in FIG. 11, the battery (40) is secured by the adjusting frames (20), the abutting frames (30), and the fixed platform (10), and when the battery (40) needs to be moved, the setup ensures that the battery (40) remains stable without moving and shaking, so as to apply the present invention in power generation equipment that requires mobility such as portable solar panels.

In another embodiment, the nut (B) is a butterfly nut, and the screw (D) is a butterfly screw, so as to allow the user to easily turn the nut (B) and the screw (D) by hand.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A mounting rack for energy storage battery comprising a fixed platform, at least an adjusting frame, and two abutting frames;
wherein each of two lateral sides of the fixed platform has a guide rail, and a plurality of sliding plates are abutted against the inner top surface of the guide rail, and each of the guide rails has a guide groove formed at the top thereof;
wherein the adjusting frame comprises a top adjustment member, and an adjustment protrude protrudes from the center of the top adjustment member, and each of two lateral sides of the adjustment protrude has a top wing plate; a height difference is formed between the adjustment protrude and the top wing plates, and the adjustment protrude is secured at the front and rear by a nut paired with a screw rod which passes through the guide groove and locks with a sliding plate, so that the adjusting frame is adapted to slide along the guide rail; each of the front and rear sides of the top wing plate comprises an elongated hole and a side adjustment member, and a clamping portion protrudes from the center of the side adjustment member; each of two sides of the clamping portion has a bottom wing plate, and a stop plate is formed at the rear end of the bottom wing plate; the adjustment protrude is configured to snap and engage into the clamping portion, and each of two adjacent elongated holes has a screw passing therethrough to pair with a nut, so as to assemble the top wing plate with the side adjustment member, and the side adjustment member is adapted to slide back and forth relative to the top adjustment member;
wherein the abutting frame has an abutting plate at one lateral side thereof, and the front and rear of the abutting frame are secured with a nut paired with a screw which passes through the guide groove and locks with a sliding plate, so that the abutting frame is configured to slide along the guide rail; and
wherein at least a battery is positioned on the fixed platform, and the two abutting frames are configured to slide and approach to the two lateral sides of the battery, and the abutting plates are abutted against the two lateral sides of the battery, thereby securing the battery from the two lateral sides thereof; the top wing plate is abutted against the top surface of the battery, and the movable stop plates are adapted to move to abut against the front side and rear side of the battery, so as to secure the position of the battery by pressing from six directions thereof; the adjustment protrude is faced up to only abut the top wing plate against the battery or is faced down to insert and engage into the clamping portion so that the adjustment protrude is positioned between the two batteries so as to achieve the separating effect; by tightening the sliding plates, the nuts, the screw rods, and the screws, the guide rails, the adjusting frame, and the abutting frames are securely positioned so as to tightly secure the battery in position.

2. The mounting rack for energy storage battery of claim 1, wherein the mounting rack for energy storage battery comprises two auxiliary limiting frames, and each of the auxiliary limiting frames has a limiting plate at one lateral side thereof; the auxiliary limiting frames are adapted to abut against the two top lateral sides of the battery, and the auxiliary limiting frame is secured at the front and rear by using a nut and a screw, which passes through the guide groove and is locked onto a sliding plate, so as to enable the auxiliary limiting frame to slide along the guide rail; and the limiting plates are abutted against the two lateral sides of the battery, thereby securing the position of the battery firmly.

3. The mounting rack for energy storage battery of claim 1, wherein a cover is formed on the top of the battery.

4. The mounting rack for energy storage battery of claim 2, wherein a cover is formed on the top of the battery.
